(19) United States
(12) Patent Application Publication
(10) Pub. No.: US 2015/0021917 A1
(43) Pub. Date: Jan. 22, 2015

(54) POWER GENERATING APPARATUS

(71) Applicants: Brian Sellers, Show Low, AZ (US); Zyad Kadri, Mesa, AZ (US)

(72) Inventors: Brian Sellers, Show Low, AZ (US); Zyad Kadri, Mesa, AZ (US)

(21) Appl. No.: 14/334,275

(22) Filed: Jul. 17, 2014

Related U.S. Application Data
(60) Provisional application No. 61/847,474, filed on Jul. 17, 2013.

(51) Int. Cl. F03D 1/04; F03D 9/00

(52) U.S. Cl. CPC F03D 1/04; F03D 9/002
USPC 290/52

(57) ABSTRACT

A power generating apparatus is provided. The power generating apparatus includes a body portion having an inner volume, the body portion having an intake on one end of the body portion and an outlet on an opposing end. The power generating device also includes a rotor operatively coupled within the body portion, wherein the rotor comprises an aperture extending from one end to an opposing end. Further included is a coiled wire coupled within the body portion and around the rotor, wherein the rotor rotates with respect to the coiled wire. The power generating apparatus also includes magnets coupled to the rotor proximate the coiled wire and a fan blade coupled within the rotor. As air is moved through the power generating apparatus, the fan blades turn the rotor and the magnets. This rotation changes the magnetic field induced on the coiled wire and creates electricity in the coiled wire.

### CROSS REFERENCE TO RELATED APPLICATION[S]

This application claims priority to U.S. Provisional Patent Application entitled “Power Generating Apparatus,” Ser. No. 61/847,474, filed Jul. 17, 2013, now pending, the disclosure of which is hereby incorporated entirely herein by reference.

### BACKGROUND OF THE INVENTION

1. Technical Field

This invention relates generally to a power generating apparatus and more particularly to a power generating apparatus that utilizes the rotation of a magnet in proximity to a coiled wire to generate electricity.

2. State of the Art

Faraday's Law of Induction teaches that changing the magnetic environment in proximity to a coil of wire cases a voltage to be induced in the coil. In other words, when a magnet is moved into a coil of wire, the magnet changes the magnetic field and magnetic flux through the coil and a voltage will be generated in the coil as a result. Electricity can therefore be generated by changing the magnetic field that is in proximity to a coil of wire.

Conventional electric generators lack in the ability to utilize a renewable energy source to operate a power generator that utilizes Faraday's Law to produce electricity. Accordingly, there is a need for an improved power generating apparatus in order to fully utilize a Faraday's Law based electricity generation system.

### DISCLOSURE OF THE INVENTION

The present invention relates to a power generating device that utilizes magnetic fields to induce electricity in a coiled wire by rotating a magnet with respect to the coiled wire. The magnet rotates in response to forced air that engages a rotor device.

An embodiment includes a power generating apparatus comprising a body portion having an inner volume, the body portion comprising an intake on one end of the body portion and an outlet on an opposing end of body portion, a rotor operatively coupled within the body portion, wherein the rotor comprises an aperture extending from one end to an opposing end, such that the aperture is in fluid communication with the intake and outlet of the body portion, a coiled wire coupled within the body portion and around the rotor, wherein the rotor rotates with respect to the coiled wire, magnets coupled to the rotor proximate the coiled wire, and a fan blade coupled within the rotor, wherein: air is directed by the intake of the body portion through the aperture of the rotor, the fan blade rotates in response to the air travelling through the aperture of the rotor, the rotor rotates in response to rotation of the fan, the magnet rotates in response to rotation of the rotor, and the magnetic field changes in response to rotation of the magnets to create electricity in the coiled wire.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, the Figures are not necessarily drawn to scale, and:

FIG. 1 is a perspective view of a power generating apparatus;

FIG. 2 is a side section view of a power generating apparatus;

FIG. 3 is a schematic view of a plurality of power generating apparatuses forming a power generation system;

FIG. 4 is a side view of another power generating apparatus;

FIG. 5 is a section view of the power generating apparatus of FIG. 4 taken along line 5-5; and

FIG. 6 is a flow chart of a method of using a power generating apparatus.

### DETAILED DESCRIPTION OF EMBODIMENTS OF THE INVENTION

As discussed above, embodiments of the present invention relate to a power generating device that utilizes magnetic fields to induce electricity in a coiled wire by rotating a magnet with respect to the coiled wire. The magnet rotates in response to forced air that engages a rotor device. Embodiments of the present invention utilize the Faraday's Law in order to generate electricity, but do so by utilizing a ram-air intake.

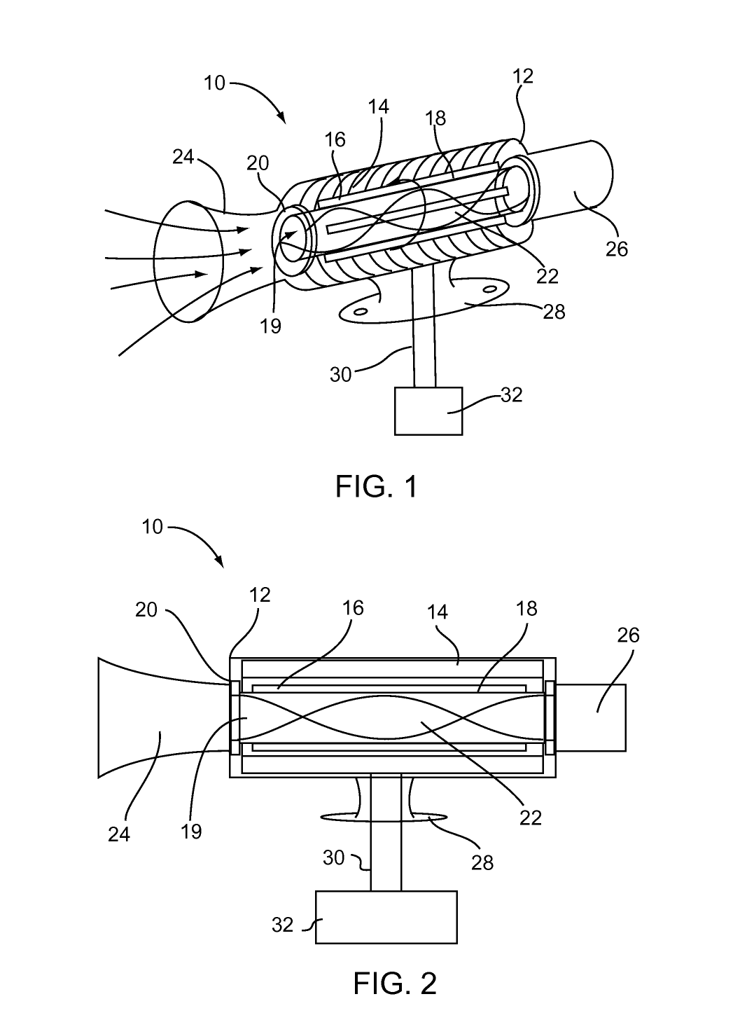

Referring to the drawings, FIGS. 1 and 2 depict a power generating apparatus 10, or power generator 10. Power generator 10 includes a body portion 12 with an intake 24 on one end of body portion 12 and an outlet 26 on an opposing end of body portion 12. Power generator 10 also includes a base portion 28 coupled to body portion 12. Base portion 28 may be utilized to mount power generator 10 to a vehicle or other type of moving body, such as, but not limited to automobiles, trains, planes, helicopters, boats, submarines and the like.

Body portion 12 includes an inner volume. Within the inner volume, power generator 10 includes a stator 14 comprising a coiled wire, coiled around a rotor 18. The rotor 18 includes an aperture 19 extending from one end of body portion 12 to the opposing end. Accordingly, an aperture extends through intake 24, body portion 12 and outlet 26, such that air can pass through power generator from intake 24 through outlet 26.

Operatively coupled within aperture 19 of rotor 18 is fan blade 22. In some embodiments, more than one fan blade 22 may be utilized and explanations of use of a single fan blade 22 can be equally applied to embodiments with more than one fan blade 22. Rotor 18 includes bearings 20 coupled on opposing ends wherein rotor 18 rotates with respect to coiled wire 14 because of the function of the bearings 20. In other words, coil 14 is maintained in a stationary position while rotor 18 rotates. Power generator 10 further includes magnets 16 coupled to rotor 18, wherein magnets 16 are in close proximity to coiled wire 14. Rotation of rotor 18 rotates magnets 16 such that the magnetic field proximate to coiled wire 14 is changed and thereby induces a voltage through coiled wire 14.

In operation, power generator 10 is coupled to a vehicle, with intake 24 of power generator 10 facing in a direction of travel of the vehicle. As the vehicle travels, ram air is directed into intake 24. According to embodiments, intake 24 is a ram-air intake. Further, air intake 24 maybe a Venturi form, such as, but not limited to a funnel shape, tapered, or the like, wherein the flow of the ram-air through the intake 24 has a Venturi effect as air flows from a larger opening through a more constricted opening in order to increase the speed of the air flow. As air is directed into intake 24, the air travels through aperture 19 of rotor 18 at a speed greater than when entering the intake 24. As the air travels through aperture 19, the air engages fan blade 22 and rotates rotor 18. The air exits at outlet 26. In some embodiments, the aperture 19 may also be tapered so that the air speed increases as it travels over the fan blade 22. This increase in air speed increases the speed of rotation of the fan blades 22. As the rotor 18 rotates, the magnetic field is changed and electricity generated in the coiled wire 14. The electricity flows through wires 30 to an external component 32.

External component 32 may be a manifold, an electric motor, a rechargeable battery, lights, or any other electrical device. It is contemplated that such a device may be utilized on electric vehicles to increase the range of travel between charges by charging the batteries of the electric vehicles, with hybrid cars to provide power directly to the electric motor or hybrid motor, and any other possible use of such a device, including without limitation all electronic devices on a vehicle when the vehicle is in motion. For example and without limitation, a train, an RV, a bus, a boat, a plane, and any vehicle may utilize power generator 10 to power components on the vehicle, such as lights in a passenger compartment, kitchen items and the like.

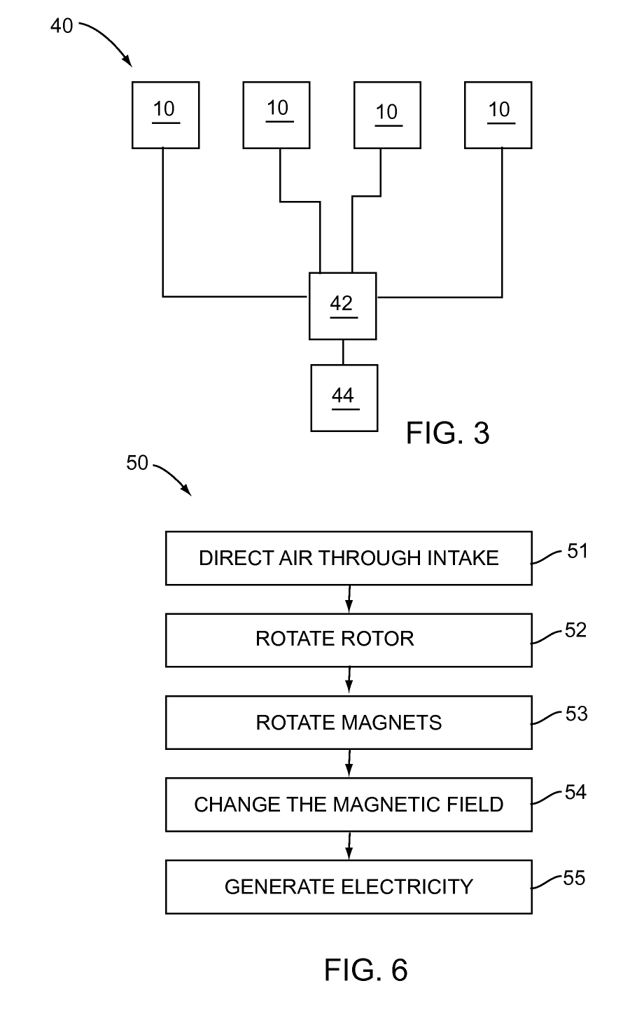

Referring further to the drawings, FIG. 3 depicts a power generation system 40, wherein power generation system 40 includes a plurality of power generators 10. Each power generator 10 operates as previously described to produce electricity, and the electricity is directed to a junction box 42. Junction box 42 can then use all collected electricity and direct it through a single main power line to an external component 44. External component 44 may include a manifold, an electric motor, a rechargeable battery, lights, or any other electrical device.

According to some embodiments, fan blade 22 may be a helical fan blade. A helical fan blade extends from one end of rotor 18 to the opposing end, wherein helical fan blade 22 is one single unit extending as a twisted blade through aperture 19 such that air travelling through aperture 19 engages fan blade 22 through the entire length of aperture 19. In other embodiments, more than one helical fan blade 22 may be utilized.

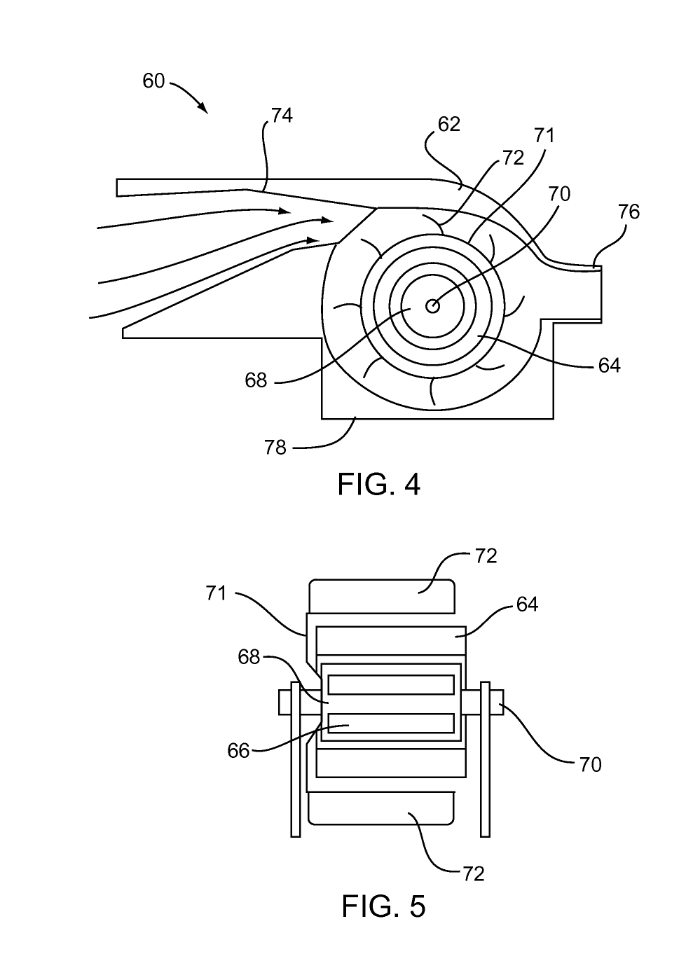

Referring again to the drawings, FIGS. 4 and 5 depict a power generating apparatus 60, or power generator 60. Power generator 60 includes a body portion 62 with an intake 74 on one end of body portion 62 and an outlet 76 on an opposing end of body portion 62. Power generator 60 also includes a base portion 78 coupled to body portion 62. Base portion 78 may be utilized to mount power generator 60 to a vehicle or other type of moving body, such as, but not limited to automobiles, trains, planes, helicopters, boats, submarines and the like.

Body portion 62 includes an inner volume. Within the inner volume, power generator 60 includes a stator 64 comprising a coiled wire, a rotor 68, a rotating member 71 and a multiple fan blades 72 coupled around the rotating member 71, wherein the fan blades 72 are evenly distributed around the rotating member 71.

The rotor 68 may be concentrically coupled to the rotating member 71 with axle 70, which includes bearings 73. This coupling allows the rotating member 71 and the rotor 68 to rotate together about the axle 70. The axle 70 extends in a direction transverse to the direction of the flow of ram air that enters the power generator 60. The stator 64 is coupled in a stationary position between the rotating member 71 and the rotor 68.

Power generator 60 further includes magnets 66 coupled to rotor 68, wherein magnets 66 are in close proximity to the coiled wire of stator 64. Rotation of rotor 68 rotates magnets 66 such that the magnetic field proximate to coiled wire of the stator 64 is changed and thereby induces a voltage through the coiled wire of the stator 64.

In operation, power generator 60 is coupled to a vehicle, with intake 74 of power generator 60 facing in a direction of travel of the vehicle. As the vehicle travels, ram air is directed into intake 74. According to embodiments, intake 74 is a ram-air intake. Further, air intake 74 maybe a Venturi form, such as, but not limited to a funnel shape, tapered, or the like, wherein the flow of the ram-air through the intake 74 has a Venturi effect as air flows from a larger opening through a more constricted opening in order to increase the speed of the air flow. As air is directed into intake 74, the air engages fan blades 72 and rotates the rotating member 71 around the stator 64 and rotates the rotor 68 within the stator 64. The air exits at outlet 76. As the rotor 68 rotates, the magnetic field is changed by the rotating of magnets 66 and electricity is generated in the coiled wires of the stator 64. The electricity flows through wires to an external component.

According to embodiments, the power generating apparatus 10 may further include a fan (not shown) for cooling the components of the power generating apparatus 10. In other embodiments, the ram air may be redirected for cooling purposes, or a portion of the ram air entering the intake 24 may be directed for cooling purposes.

According to other embodiments, the power generating apparatus 10 may include stents (not shown), wherein the stents extend through the body portion 12 in proximity to the bearings 20. The stents allow for maintenance of the bearings 20, such as applying additional grease and the like.

Further still, according to embodiments, the power generating apparatus 10 may include a screening device (not shown), wherein the screening device is operatively coupled to the intake 24. The screening device may be a mesh coupled over the opening of the intake 24, wherein the mesh inhibits debris, bugs and the like from entering the power generating apparatus 10. This operates to decrease the opportunity of damage to internal components that may be caused by debris, bugs and the like entering therein.

Referring further to the drawings, FIG. 6 depicts a flow chart of a method 50 of using a power generating apparatus. Method 50 includes directing air through an intake of a power generator (Step 51); rotating a rotor in response to air engaging a fan blade of the power generator (Step 52); rotating magnets coupled to the rotor and proximate a coiled wire coupled around the rotor, wherein the magnets rotate with respect to the coiled wire (Step 53); changing the magnetic field induced on the coiled wire (Step 54); and generating electricity in the coiled wire in response to changing the magnetic field induced on the coiled wire (Step 55).

The method 50 may further include directing power to an external component. This step of directing power to an external component may include directing electricity to a rechargeable battery, to an engine, a manifold or the like, including without limitation, any electric device on a vehicle that needs a supply of electricity to operate.

The method 50 may further include generating an air flow that engages the fan blade of the power generator, which may include, for example, displacing, or otherwise moving, the generator in the air to generate the flow of air that engages the fan blade. Such movement of the generator may be produced by operatively coupling the power generator to a motorized vehicle. Accordingly, the method 50 may further include operating a motorized vehicle to generate the air flow that engages the fan blade.

In some embodiments, power generator 10 may further be used as a ram-air intake of a vehicle, wherein once the air exits outlet 26, it is directed to the air intake of the engine in order to improve efficiency of the engine. In at least this way, power generator 10 has a second function when coupled to a vehicle having an internal combustion engine.

Additionally, while it is shown that the present invention is used with air or ram air, it is also contemplated that the power generating apparatus may operate in any type of fluid, such as water and the like, wherein the fluid travels through the power generating apparatus in the same manner as the air. In this way, the power generating apparatus may operate in any fluid.

Accordingly, the components defining any power generating apparatus may be formed of any of many different types of materials or combinations thereof that can readily be formed into shaped objects provided that the components selected are consistent with the intended operation of a power generating apparatus. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any power generating apparatus may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A power generating apparatus comprising:
a body portion having an inner volume, the body portion comprising an intake on one end of the body portion and an outlet on an opposing end of body portion;
a rotor operatively coupled within the body portion, wherein the rotor comprises an aperture extending from one end to an opposing end, such that the aperture is in fluid communication with the intake and outlet of the body portion;
a stator including coiled wire coupled within the body portion and around the rotor, wherein the rotor rotates with respect to the coiled wire;
magnets coupled to the rotor proximate the coiled wire; and
a helical fan blade coupled within the rotor, the helical fan blade extending along the length of the rotor, wherein:
ram air is directed by the intake of the body portion through the aperture of the rotor;
the helical fan blade rotates in response to the air travelling through the aperture of the rotor;
the rotor rotates in response to rotation of the helical fan blade;
the magnets rotate in response to rotation of the rotor; and
the magnetic field changes in response to rotation of the magnets to create electricity in the coiled wire of the stator.

2. The apparatus of claim 1, wherein the intake comprises a Venturi form.

3. The apparatus of claim 1, wherein the aperture of the rotor is tapered, wherein the ram air traveling through the aperture accelerates.

4. The apparatus of claim 1, further comprising an external component, wherein electricity generated in the coiled wires of the stator are directed to the external component.

5. The apparatus of claim 1, further comprising multiple power generating apparatuses.

6. The apparatus of claim 5, further comprising a junction box, wherein the electricity from each power generating apparatus is directed to the junction box.

7. The apparatus of claim 6, further comprising an external component, wherein electricity from the junction box is directed to the external component.

8. A power generating apparatus comprising:
a body portion having an inner volume, the body portion comprising an intake on one end of the body portion and an outlet on an opposing end of body portion, wherein the intake includes a Venturi form;
a rotor operatively coupled within the body portion;
a stator comprising a coiled wire coupled in a stationary position within the body portion and around the rotor, wherein the rotor rotates with respect to the stator;
magnets coupled to the rotor proximate the coiled wire; and
multiple fan blades operatively coupled to the rotor, wherein ram air enters the intake and engages the fan blades to rotate the rotor, wherein electricity is generated in response to rotation of the rotor with respect to the stator.

9. The apparatus of claim 8, wherein the rotor comprises an aperture extending from one end to an opposing end, such that the aperture is in fluid communication with the intake and outlet of the body portion.

10. The apparatus of claim 9, wherein the multiple fan blades are helical fan blades coupled within the rotor, the helical fan blades extending along the length of the rotor.

11. The apparatus of claim 10, wherein ram air is directed by the intake of the body portion through the aperture of the rotor; the helical fan blades rotate in response to the air travelling through the aperture of the rotor; the rotor rotates in response to rotation of the helical fan blades; and the magnets rotate in response to rotation of the rotor.

12. The apparatus of claim 8, further comprising a rotating member, wherein the fan blades are coupled to the rotating member to allow for rotation of the rotating member about an axle transverse to the flow of ram air.

13. The apparatus of claim 12, wherein the rotating member is concentrically coupled to the rotor about the axle.

14. The apparatus of claim 13, wherein the stator is coupled between rotating member and the rotor, wherein as ram air engages the fan blades, the rotating member rotates around the stator and the rotor rotates within the stator.

15. The apparatus of claim 8, further comprising an external component, wherein electricity generated in the coiled wires of the stator are directed to the external component.

16. A method of using a ram air power generating apparatus; the method comprising:
directing ram air through an intake of a power generator;
rotating a rotor in response to air engaging a fan blade of the power generator;
rotating magnets coupled to the rotor and proximate a stator comprising a coiled wire coupled around the rotor, wherein the magnets rotate with respect to the coiled wire;
changing the magnetic field induced on the coiled wire; and
generating electricity in the coiled wire in response to changing the magnetic field induced on the coiled wire.

17. The method of claim 16, further comprising directing power to an external component.

18. The method of claim 17, wherein directing power to the external component is one of directing electricity to a rechargeable battery, directing electricity to an engine, directing electricity to an electric motor, directing electricity to a manifold or directing electricity to any electric device on a vehicle that needs a supply of electricity to operate.

19. The method of claim 16, further comprising coupling the power generator to a vehicle.

20. The method of claim 19, further comprising generating ram air in response to operating the vehicle.
